(19) United States
(12) Patent Application Publication
(10) Pub. No.: US 2011/0231894 A1
(43) Pub. Date: Sep. 22, 2011

(54) Systems and Methods for Mediating an Internet Service Delivered to a Particular Location

(76) Inventor: Tom C. Tovar, San Francisco, CA (US)

(21) Appl. No.: 12/897,430

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00

(52) U.S. Cl. 726/1

(57) ABSTRACT

Systems and methods for an Internet service delivered to a selected location are provided herein. According to some exemplary embodiments a method for mediating an Internet service delivered to a selected location having an Internet connection operatively coupling at least one user device to the Internet service includes executing instructions stored in a memory by a processor to prevent delivery of restricted Internet content via the Internet service. The restricted Internet content includes Internet content included in one or more categories of restricted Internet content included in a mediation policy adapted to be selectively applied to the Internet service.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to mediating an Internet service delivered to a particular location having an Internet connection operatively coupling at least one user device to the Internet service, and more specifically, but not by way of limitation, to systems and methods that prevent delivery of restricted Internet content that includes Internet content in one or more categories of restricted Internet content of a mediation policy adapted to be selectively applied to the Internet service.

### SUMMARY OF THE INVENTION

According to exemplary embodiments, the present invention provides methods for mediating the delivery of Internet service to a particular location having an Internet connection operatively coupling at least one user device to an Internet service providing Internet content, the methods including executing instructions stored in a memory by a processor to prevent delivery of restricted Internet content via the Internet service, wherein restricted Internet content includes Internet content included in one or more categories of restricted Internet content of a mediation policy adapted by a user to be selectively applied to the Internet service.

According to other exemplary embodiments, the present invention is directed to systems for mediating an Internet service delivered to a particular location having an Internet connection operatively coupling at least one user device to the Internet service, the systems including a user interface between users with administrative authority and the Internet service used to execute a mediation policy, a memory for storing a mediation policy application and a processor for executing instructions stored in a memory by a processor to prevent delivery of restricted Internet content via the Internet service, wherein restricted Internet content includes Internet content included in one or more categories of restricted Internet content of a mediation policy adapted by a user to be selectively applied to the Internet service. The Internet service may be set up to use the DNS (Domain Name System) on a server or on a cloud based networking system.

According to additional exemplary embodiments, the present invention is directed to computer readable storage media having a program embodied thereon, the program executable by a processor in a computing system to perform methods for mediating an Internet service delivered to a particular location having an Internet connection operatively coupling at least one user device to the Internet service, the methods including executing instructions stored in a memory by a processor to prevent delivery of restricted Internet content via the Internet service, wherein restricted Internet content includes Internet content included in one or more categories of restricted Internet content of a mediation policy adapted by a user to be selectively applied to the Internet service.

### BRIEF DESCRIPTION OF THE DRAWINGS

FIG. 1 is an exemplary architecture of a mediation policy application in accordance with various embodiments of the present invention.

FIG. 2 is a flow chart of an exemplary method for creating and selectively applying a mediation policy to an Internet service.

FIG. 3 is an exemplary representation of a web page for subscribing to the mediation application.

FIG. 4A is an exemplary representation of a web page such as a configuration drawer for creating and/or editing a master mediation policy.

FIG. 4B is an exemplary representation of a blocking web page.

FIG. 5 is a block diagram of a DNS network arrangement in accordance with various embodiments of the present invention.

FIG. 6 is a block diagram of an exemplary system for providing variable content control for an Internet user in accordance with various embodiments of the present invention.

FIG. 7 is a block diagram of an exemplary system for providing notifications regarding Internet access in accordance with various embodiments of the present invention.

### DETAILED DESCRIPTION OF EXEMPLARY EMBODIMENTS

Generally speaking, an administrator may create and enforce mediation polices for one or more end users that utilize computing devices coupled to an Internet service delivered to a location such as a home, residence or place of business or campus.

It will be further understood that because of the diversity of computing devices that may connect to the Internet service, the mediation policy may be applied to the Internet service rather than requiring the policy to affect each computing device individually, such as a mediation application resident on each computing device. In various exemplary embodiments a policy may also reside as a stand alone application on one or more of the computing devices.

Exemplary user devices for use with the disclosed systems may have a user interface. In various embodiments, such as those deployed on personal mobile devices, the user interface may be, or may execute, an application, such as a mobile application (hereinafter referred to as an “app”). An app may be downloaded and installed on a user's mobile device. Users may define a mediation policy via a user device, such as through the user interface. Some embodiments of the present invention do not require software to be downloaded or installed locally to the user device and, correspondently, do not require the user to execute a de-install application to cease use of the system.

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology is directed to systems and methods for mediating the delivery of Internet service delivered to a particular location. More specifically, the systems and methods allow for the creation and enforcement of a master mediation policy that applies to the Internet connection providing Internet service to a particular location. It will be understood that the term “master” as used to describe mediation policies may refer to mediation policies that establish a baseline or household-level set of rules regarding appropriate Internet conduct that apply to all end users accessing the Internet through the Internet connection of a particular location.

The master mediation policy may prevent delivery of restricted Internet content by the Internet service, wherein restricted Internet content includes Internet content included in one or more categories of Internet content the administrator does not want in their home. In some embodiments, end users may augment the master mediation policy to create an individualized mediation policy that includes additional categories of restricted Internet content.

Generally speaking, an administrator may create and enforce master mediation polices for all end users that utilize computing systems coupled to an Internet service via the Internet connection delivered to a particular location, such as a residence or place of business. The term “administrator” may include not only individuals, such as parents, but also any individual creating baseline, location specific mediation policies regarding the Internet service delivered to end users. It will be understood that an administrator may also be an end user, although end users who are not also administrators may not create or apply master or individualized mediation policies unless allowed to do so by the administrator.

It will be further understood that because of the diversity of computing systems that may connect to the Internet service, the master mediation policy may be applied to the Internet service, rather than requiring the master mediation policy to affect each computing system individually, such as a master mediation policy application resident on each computing system, although, in various exemplary embodiments a master mediation policy may also reside on one or more of the computing systems.

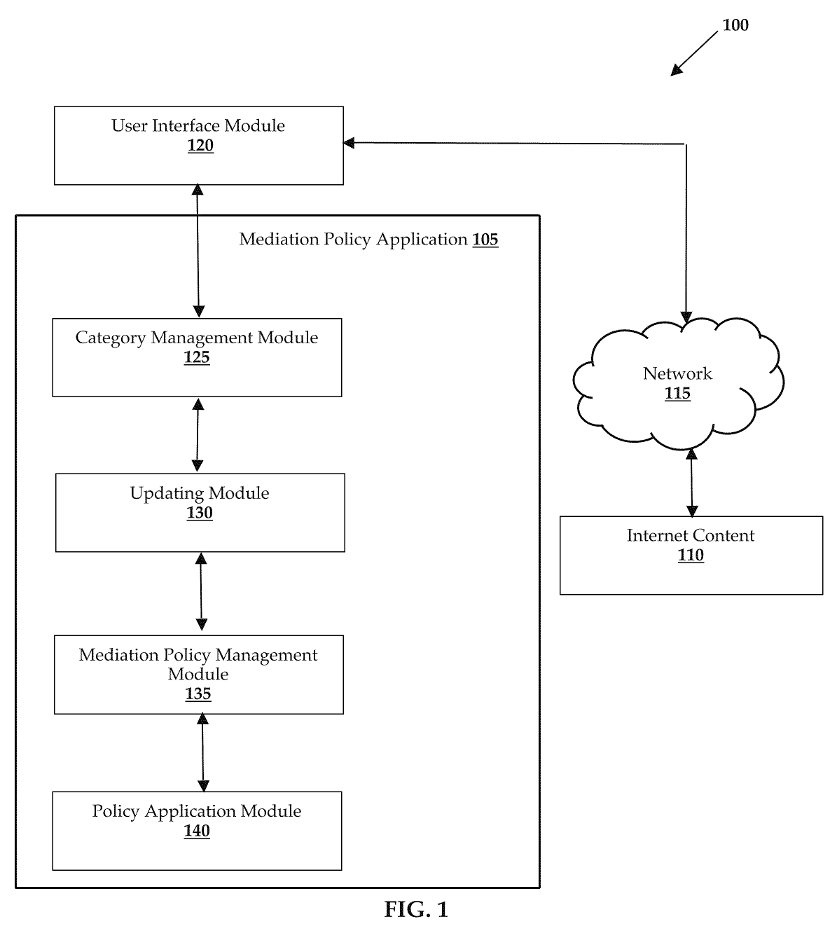

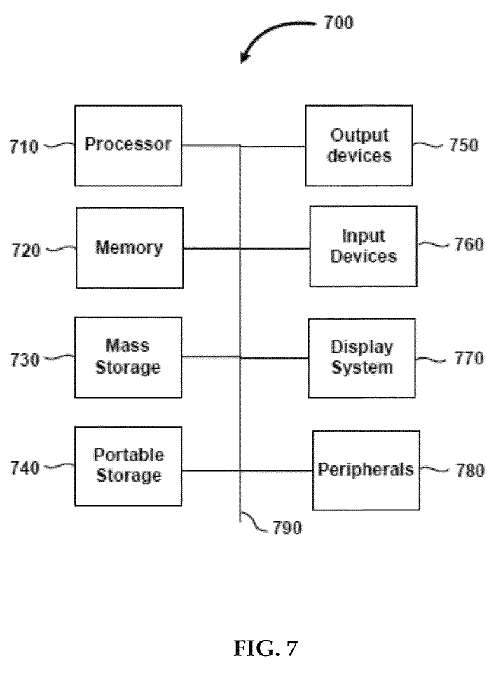

Referring now to FIG. 1, an exemplary architecture 100 of an exemplary mediation policy application 105 resident on the computing system (described in greater detail in FIG. 7 as computing system 700) is shown. The computing system 700 may access the Internet content 110 by way of a common Internet connection (not shown) operatively coupling each computing system 700 within the particular location to the Internet content 110. Common types of Internet connections include cable and DSL modems, and the like.

The computing system 700 may access Internet content 110 via network 115 (by way of the Internet connection) utilizing user interfaces generated by the user interface module 120. Generally speaking, the mediation policy application 105 allows an administrator to create and selectively apply a customized master mediation policy having Internet content included in one or more categories of restricted Internet content. It will be understood that the one or more categories of restricted Internet content may include subject matter such as adult, gambling, alcohol, tobacco, illegal drugs, firearms, violence, racism, politics, commerce, gaming, or combinations thereof. Additionally, the categories of restricted Internet content may include end user-defined categories as will be discussed in greater detail herein.

It is important to note that the mediation policy application does not simply provide blocking mechanisms by masking or enabling network controls, but rather mediates an Internet service delivered to a particular location. As used herein, mediating the Internet service may include any of blocking, constraining, enabling, redirecting, promoting, demoting, substituting, obscuring, limiting, interrupting, and restricting all or a portion of the Internet service.

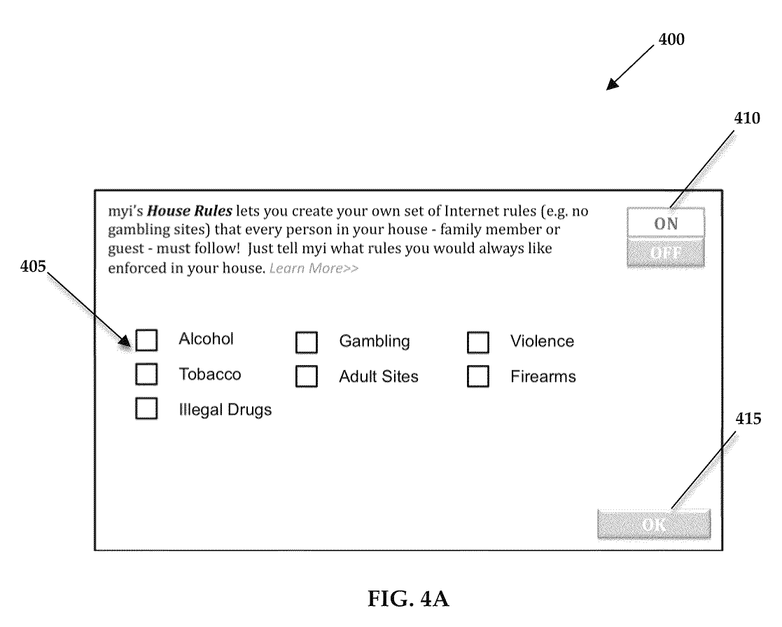

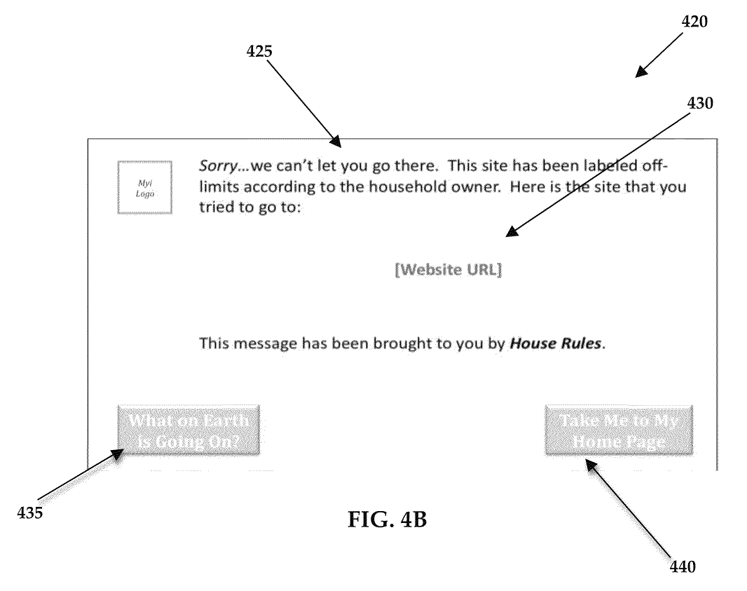

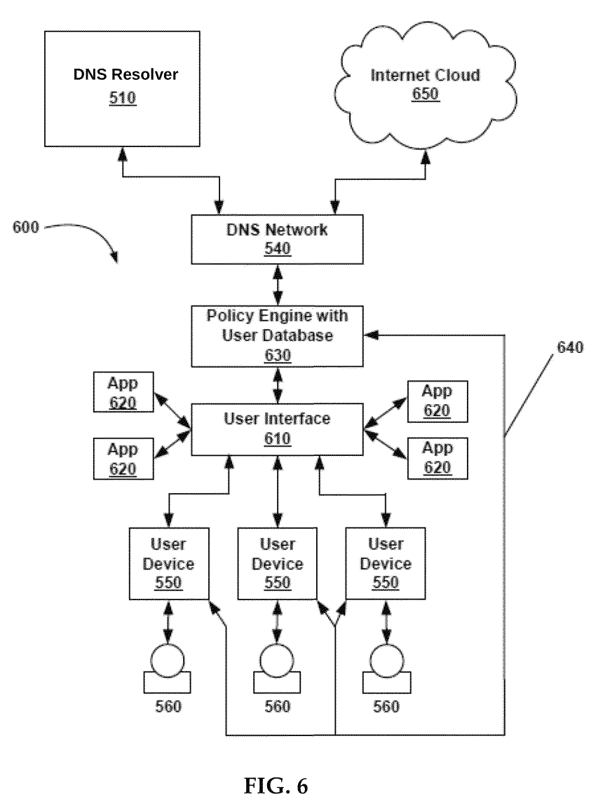

According to exemplary embodiments, the mediation policy application 105 allows for the creation of master mediation polices via a user interface such as a web page. A user interface module 120 may generate the user interface 610 (see FIG. 6). The user interface 610 may be implemented in many embodiments, although in various exemplary implementations, the user interface 610 includes web page 400 adapted to receive mediation information from an administrator, as illustrated in FIG. 4A.

According to exemplary embodiments, the mediation policy application 105 may include a category management module 125, an updating module 130, a mediation policy management module 135, and a policy application module 140. It is noteworthy that the mediation policy application 105 may be composed of more or fewer modules and engines (or combinations of the same) and still fall within the scope of the present technology.

In general, the mediation policy application 105 creates and maintains one or more categories of restricted Internet content via the category management module 125 and updating module 130, and allows administrators to create master mediation policies via the mediation policy management module 135. The master mediation policies are then enforced by a dynamic enforcement engine 520, which prevents delivery of restricted Internet content included in the master mediation policy.

The category management module 125 defines the Internet content 110 included in the one or more categories of restricted Internet content by first evaluating Internet content 110 for subject matter. It will be understood that the Internet content 110 may be gathered or received for evaluation by the category management module 125 according to various methods that would be known to one of ordinary skill in the art with the present disclosure before them. The category management module 125 may be adapted to evaluate the subject matter of the Internet content 110 to determine which (if any) of the one or more categories of restricted Internet content correspond to the subject matter of the evaluated Internet content 110. It will be understood that the subject matter of the Internet content 110 may correspond to more than one category.

Once the category management module 125 has determined one or more appropriate categories of restricted Internet content that correspond to the subject matter of the Internet content 110, the category management module 125 may associate the Internet content 110 with the corresponding category or categories of restricted Internet content. More specifically, the category management module 125 may establish and maintain one or more category records corresponding to each category of restricted Internet content. The records may reside on one or more servers located within Internet cloud 650 (see FIG. 6).

Because of the dynamic nature (e.g., creation, deletion, modification, transfer, loss, etc.) of Internet content 110, the one or more categories of restricted Internet content may be updated by updating module 130. The updating module 130 may be executed periodically or continuously to evaluate the subject matter of additional Internet content 110. The updating module 130 may add the additional Internet content 110 to one or more of the categories of restricted Internet content based at least in part on the subject matter of the additional Internet content 110. The updating module 130 allows the one or more categories of restricted Internet content to evolve and/or grow over time as the Internet content 110 changes. For example, a website that originally included educational subject matter may be re-purposed for Internet gaming by a subsequent owner and would therefore be re-associated by the category management module 125 from a category that includes educational Internet content to a category that includes Internet gaming.

To create a master mediation policy, the mediation policy management module 135 may execute the user interface module 120 to create a web page that displays a plurality of selections corresponding to the one or more categories of restricted Internet content, such as exemplary web page 400 of FIG. 4A. The one or more categories of restricted Internet content may be displayed in any number of ways such that the administrator may choose one or more of the categories of restricted Internet content to add to the master mediation policy. Once selected, the Internet content 110 associated with the one or more categories of restricted Internet content is added to the master mediation policy by the mediation policy management module 135. The master mediation policy may be stored in the form of a user record that resides on one or more servers located within Internet cloud 650. The administrator may modify the master mediation policy at any time by selecting and/or removing categories of restricted Internet content via the web page 400.

Once established, access to the configuration of the master mediation policy may be password protected to prevent other end users from modifying or preventing application of the master mediation policy to the Internet service.

With regard to creating individualized mediation policies, it will be understood that value systems can vary widely between individual end users. For example, a homeowner may desire to establish a master mediation policy that prevents every end user from accessing pornographic Internet content from the Internet connection that operatively connects computing systems in the home to the Internet service. It will be understood that the master mediation policy may not apply to Internet connections such as WIFI signals that emanate from outside the home. Even though the homeowner may have established a master mediation policy, one or more end users may desire to block certain other types of Internet content. Continuing with the example, an end user may desire to block all social networking Internet content in addition to the Internet content included in the master mediation policy.

Therefore, the mediation policy management module 135 may be adapted to receive additional selections of one or more categories of restricted Internet content from another end user. The selections are displayed and input received from the end user similarly to displaying and receiving input from the administrator for creating and maintaining the master mediation policy. It will be understood that the end user may not modify the categories of restricted Internet content previously selected by the administrator, but may add or remove additional categories of restricted Internet content.

Generally speaking, the categories of restricted Internet content may be established and maintained by an outside entity such as a product service provider. As such, the categories may be broad so as to encompass the needs of a broad range of end users. In some instances, these provider-established categories of restricted Internet content may not be appropriate for all end users. Therefore, the administrator may desire to create customized categories of restricted Internet content.

Customized categories of restricted Internet content may be created by the mediation policy application 105 receiving a request to create a customized category of restricted Internet content from an end user or administrator. The requests are evaluated according to a predetermined category creation policy established by the product service provider. The category creation policy established by the product service provider may include any type or number of limitations established by the product service provider.

If the request complies with the category creation policy, the category management module 125 may create and establish the category of restricted Internet content according to the steps described previously.

In additional embodiments, administrators or end users may request the creation of an additional category of restricted Internet content by providing one or more exemplary types of Internet content 110 representative of a category that the administrator would like to create. For example, an administrator request to create an additional category of restricted Internet content may include several domains. The category management module 125 may evaluate the subject matter of the domains to determine if the domains may be associated with an existing category. If the domains do not correspond to an existing category, the category management module 125 may establish a new category of restricted Internet content corresponding to the subject matter of the domains.

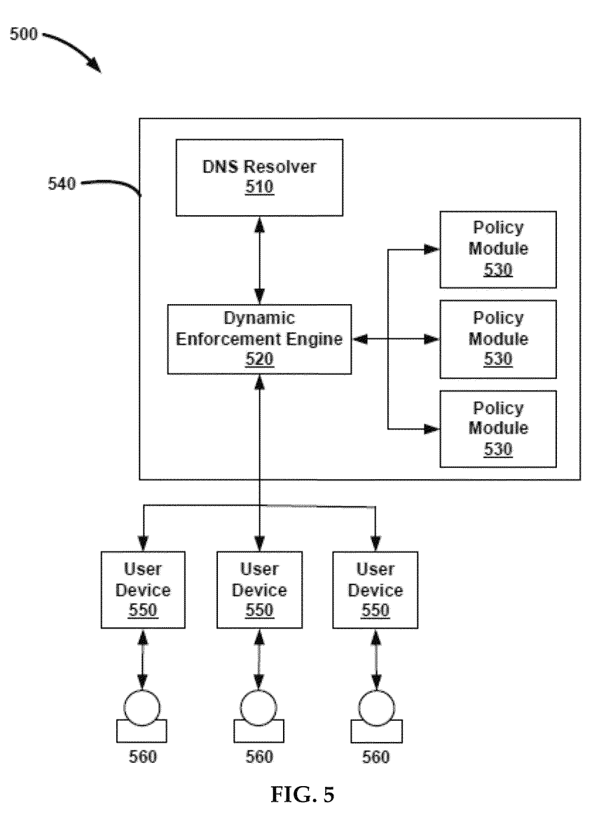

Enforcement of the master mediation policy (or an individualized mediation policy) includes the policy application module 140 applying the mediation policy to the Internet service and evaluating requests to access Internet content 110 received from a computing system operatively coupled to the Internet service via the Internet connection. If the requested Internet content 110 is included in the mediation policy, the policy application module 140 causes the dynamic enforcement engine 520 (FIG. 5) to perform at least one of the following actions: (1) prevent the DNS server 510 (FIG. 5) from resolving the Internet content 110 before the Internet service reaches the displays of the user devices 550 (FIG. 5); or (2) prevent the Internet service provider from resolving the Internet content 110 before the Internet service reaches the displays of the user devices 550. In the first case, the dynamic enforcement engine 520 may prevent the DNS server 510 from resolving the Internet content 110 by affecting commands and actions occurring on the DNS server 510. It will be understood that the policy application module 140 may reside on the DNS server 510.

The administrator, via utilization of the user interface 610, may terminate application of the mediation policy to the Internet service at any time. The user interface 610 may include a button (such as an enable/disable button 410 of exemplary FIG. 4A) or a check box that can be toggled by the administrator to enable/disable the application of the master mediation policy to the Internet service.

Additionally, if the policy application module 140 has denied access to Internet content 110, the policy application module 140 may cause the user interface module 120 to generate a user interface 610 in the form of a web page 420 (see FIG. 4B) that includes a blocking message. According to various embodiments, the user interface 610 includes a web page notifying the end user that access to the requested Internet content 110 has been denied by the mediation policy application 105.

According to other embodiments, the database may be used by the mediation policy module 125 to record and to notify administrators of various data relative to Internet access. The data collected from and provided to the administrators may include records of specific instances when access to Internet content 110 was blocked, such as when the dynamic enforcement engine 520 prevents resolution of requested Internet content 110. Additionally, the mediation policy module 125 may record an aggregate number of times Internet content 110 was blocked in a predetermined amount of time. The data collected may be organized into logs that can be stored in a user record and accessed by the user interface module 120. More specifically, the user interface module 120 may generate a web page (not shown), including log data indicative of the date and time resolutions of Internet content 110 that were denied, along with information indicative of the Internet content 110.

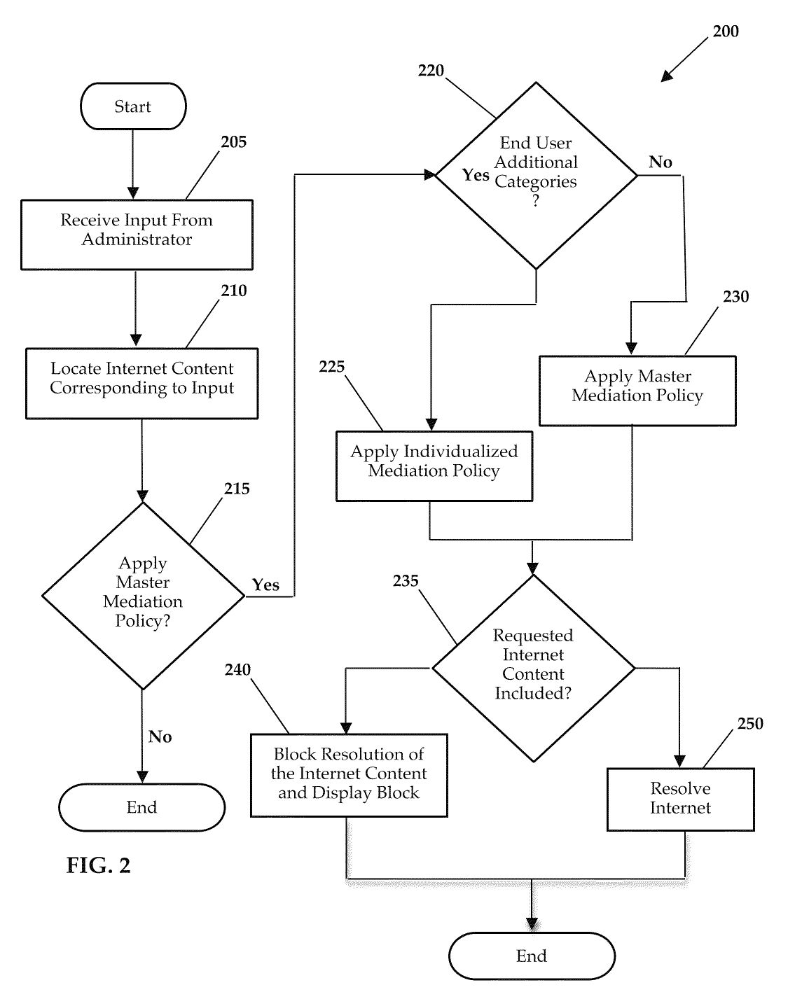

Referring now to FIG. 2, a method 200 for creating and selectively applying a mediation policy to an Internet service is illustrated. The method 200 begins with a step 205 of an administrator creating a master mediation policy for end users utilizing computing systems operatively coupled to the Internet service by an Internet connection at a particular location. The administrator supplies input via a user interface displayed on the user device. For example, the user interface may display a variety of input fields to the administrator. One or more messages may be displayed on the user interface to elicit input from the administrator. The user interface may then receive administrator input indicative of selections corresponding to one or more categories of restricted Internet content.

Input received by the user interface may be utilized by the mediation policy module to create a master mediation policy for one or more end users. For example, the administrator may select the categories of social networking and gambling.

A subsequent step 210 includes the policy management module locating Internet content associated with the selected categories of restricted Internet content. The policy management module then adds the located Internet content to the master mediation policy.

In an additional step 215, the administrator may enable/disable selective application of the master mediation policy to the Internet service. The administrator may enable/disable the selective application of the master mediation policy via a button located on a user interface (such as the enable/disable button 410 of exemplary FIG. 4A). If the administrator does not enable the master mediation policy, the method 200 terminates.

In another step 220, an end user may include additional categories of restricted Internet content to create an individualized mediation policy. The end user supplies input via a user interface displayed on the user device. For example, the user interface may display a variety of input fields to the end user. One or more messages may be displayed on the user interface to elicit input from the end user. The user interface may then receive end user input indicative of selections corresponding to one or more additional categories of restricted Internet content. The input received by the user interface may be utilized by the mediation policy module to create an individualized mediation policy for the end user.

If the end user selects additional categories of restricted Internet content, step 225 applies an individualized mediation policy that includes the Internet content in the master mediation policy along with the Internet content of the additional categories of restricted Internet content. It will be understood that if the end user does not select additional categories of restricted Internet content, rather than applying an individualized mediation policy, the master mediation policy may be applied to the Internet service in step 230.

Regardless of whether the end user chooses an individualized mediation policy or defaults to the master mediation policy application, the method 200 includes a step 235 of applying the mediation policies to the Internet service to evaluate requests to access (e.g., resolve) Internet content. More specifically, each application of a mediation policy begins with an end user inputting a request to access Internet content. The end user may input this request via a browser operating on the user device. In various embodiments, a request includes clicking a hyperlink located on a web page.

If the policy application module determines that the Internet content is included in the mediation policy, the policy application module causes the dynamic enforcement engine to prevent resolution of the Internet content in step 240.

In addition to preventing resolution of the requested Internet content, the policy application module may display a notification message to the end user in the form of a blocking web page. It will be understood that the user interface module may generate the blocking web page. The blocking web page may include the following content: a message that the attempt to access the requested Internet content has been denied; a message that the attempt was blocked by the mediation policy application (which may include the trade name of the application); a message that the administrator has established that the requested Internet content be blocked; and/or any combinations thereof. The method 200 terminates after the dynamic enforcement engine prevents resolution of the Internet content and/or the user interface module generates and displays a notification message.

In contrast, if the policy application module determines that the Internet content is not included in the mediation policy, a step 250 allows the dynamic enforcement engine to permit resolution of the Internet content. The Internet content is then provided by the Internet service to the end user via the user device. It will be understood that the method terminates after resolution of the Internet content.

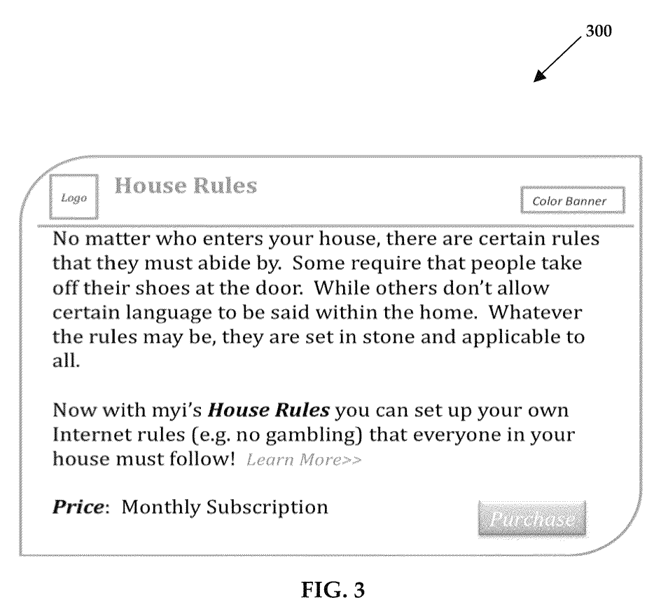

FIG. 3 illustrates an exemplary web page 300 for subscribing to the mediation policy application. The web page may include (i) content describing the functionality of the application; (ii) the name of the application (“House Rules”); (iii) a link to more detailed information; and (iv) a price description.

FIG. 4A illustrates an exemplary user interface, which in this instance includes a web page 400 in the form of a configuration drawer by which a plurality of input devices may be configured to receive input from an administrator. The web page 400 includes a plurality of checkboxes 405 that correspond to each of the one or more categories of restricted Internet content. The administrator may select one or more of the checkboxes 405 to include the associated Internet content from the selected categories of restricted Internet content to the master mediation policy.

An enable/disable button(s) 410 is included, allowing an administrator to selectively control application of the master mediation policy by enabling/disabling the functionality of the mediation policy application. Once the administrator is finished inputting information of the master mediation policy, the administrator may utilize button 415 to close the web page 400.

FIG. 4B illustrates an exemplary user interface, which in this instance includes a blocking page 420. The blocking page 420 may include a message 425 that their attempt to access the requested Internet content has been denied along with the name 430 of the restricted Internet content. The blocking page 425 may also include a button 435 (labeled as “What on Earth is Going On?”) that when clicked by the end user calls up an additional web page (not shown) that provides the end user with additional details regarding the reasons why their attempt to access the requested Internet content was restricted. Lastly, the end user may be redirect to a home page (also not shown) that may be specified by the administrator via utilization of button 440, labeled “Take Me Home.” It will be understood that the mediation policy application 105 and further the blocking page 425 may be adapted to prevent the end user from bypassing the blocking page 425 to access the restricted content.

The systems and methods described above may typically be resident in an Internet service or a DNS network. The systems and methods described may also be implemented in plug-in utilities, gateway devices, cable modems, proxy servers, set top boxes, and network interface devices.

FIG. 5 illustrates an exemplary Internet service system 500, with a DNS server, that may be utilized to support the above described systems and methods. A DNS server 510 operates in conjunction with a dynamic enforcement engine 520. The dynamic enforcement engine 520 may operate in conjunction with one or more policy modules 530 to establish any applicable polices at the DNS level. The content rules are applied to received user queries, and determine the content that is delivered by the DNS network 540 through various user devices 550 to the end users 560.

The dynamic enforcement engine 520 may generate its policy engine on instructions received from one or more policy modules 530. Each policy module 530 may be constructed to provide various types and levels of services to the DNS network 540. In various embodiments, a policy module 530 may be configured to handle queries directed to subjects including, but not limited to, malicious domain redirection, user access redirection, non-existent domain redirection, and data collection or analysis.

It will be recognized by those skilled in the art that the elements of DNS service 570 may be hosted either locally or remotely. In addition to residing in the DNS service 570, one or more of the DNS network 540, the dynamic enforcement engine 520, and the policy modules 530, and any combination thereof, may be resident on one or more user devices 550.

FIG. 6 shows a schematic layout of an exemplary system 600 for implementing direct and variable end user control. FIG. 6 illustrates that the system 600 may operate installed on a DNS server 510, or with a cloud 650 based installation.

The system 600 utilizes a user interface 610. The user interface 610 may be implemented in many embodiments. One specific implementation of the user interface 610 is as a web page.

The user interface 610 may be accessed by one or more user devices 550 operated by the users 560. The user interface 610 may be accessed though a gateway user device 550 available to the users 560. Suitable user devices 550 include but are not limited to desktops, PCs, laptops, notebooks, gaming devices, tablets, IPods, Smartphones, automobile computer systems, and Internet enabled TVs. The system 600 may also be accessed and controlled remotely through a user device 550, such as a Smartphone or other specialized Internet access devices. A Smartphone may be defined as a phone with computing capability. A Smartphone may provide the user 560 with Internet access.

The user interface 610 provides a mechanism for one or more authorized users 560 to establish content policy for the Internet service. The user interface 610 operates between the user devices 550 present in the system 600 and the DNS network 540. Instructions resident on the user interface 610 therefore operate on the Internet service, by controlling at least a portion of DNS resolutions via a dynamic policy engine 630, before the service reaches the displays of the user devices 550.

The user interface 610 provides the users 560 with access to one or more policy applications 620. The user interface 610 may provide access to a selection list to at least one authorized user 560. The authorized user 560 uses the selection list or some other menu mechanism to select those policy applications 620 that the user 560 chooses to apply to the system 600. The authorized user 560 may select any number of the available policy applications for use on the system 600 at any given time. In implementations utilizing smartphones as the user device 550, the policy applications 620 are downloaded to the device 550. The device 550 then serves as the user interface 610 to communicate directly with the dynamic policy engine 630.

The policy applications 620 may prohibit access to specific sites. The policy applications 620 may also limit the time of day when users or selected users 560 may access certain sites. The policy applications 620 may also manage and analyze duration of access to various sites. It is important to note that the policy applications 620 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 620 may provide notifications or alerts to one or more users 560 when sites are accessed. The policy applications 620 may also provide notification of frequency and duration of access of designated sites. The policy applications 620 may also be used to observe, substitute, enable, redirect users, to reward behavior desired from the users by a system administrator, etc. The policy applications 620 may redirect users from a non-favored site to another site. The policy applications 620 may also collect and transmit data characteristic of Internet use.

Access policies supplied by the policy applications 620 may apply to all users 560 of the system 600, or the access policies may be specific to individual users or groups of users 560. The policy applications 620 may be discrete, single purpose applications.

The policy applications 620 provide the users 550 with a mechanism to take various actions relative to their Internet service feed. The policy applications 620 also allow the users 550 to establish a dynamic policy engine 630 that includes a user database. The policy engine 630 is used to enforce rules associated with each policy application associated with individual end users, not simply block various inappropriate sites from the Internet feed. Rather, the dynamic policy engine 630, controlled by the user interface 610 through user device(s) 550, is used to manage all aspects of the Internet experience for the users 560. In sum, the policy applications 620 may be used to configure the dynamic policy engine 630 to provide the users 560 with a mechanism to personalize the Internet experience. The policy applications 620 may be configured in combinations, and may each be separately configured.

The database in the policy engine 630 may be used to record and to notify users 560 of various data relative to Internet access. The data collected from and provided to the users 560 may include records of access of specific sites, time spent on specific sites, time of day of access, data specific to individual users, etc.

It should also be noted that following an initial setup through the user interface 610 of the policy engine 630, a direct access 640 enforcement loop may be established between the policy engine 630 and the user devices 550. Subsequent accessing of the DNS network 540 utilizing the direct access 640 decreases response time in the system 600, thereby further enhancing the Internet experience of the users 560. Configurations of policy applications 620 that are selected by one or more users 560 designated as system administrators may remain in the user database of the policy engine 630 until such time as it may be modified by the system administrators. The system administrators may define multiple policy configurations, with a combination of policy applications 620, applicable to one or more end users 560 of the system 600. Each policy application 620 may be separately configurable as well. Policy configurations may vary based upon designated times, conditional triggers, or specific requests from the users 560 with administrative authority.

As indicated above, two discrete data flow paths may be established for the system 600. A first data path establishes a set of enforcement policies for the system 600. The first data path flows from at least one user device 550 through the user interface 610, to the policy enforcement engine 630. A second data path 640 may be utilized following the establishment of a set of policies for the system 600. The second data path 640 flows directly between the user device(s) 550 and the policy engine 630. Multiple sets of enforcement policies may be established and saved within the system 600 and implemented selectively by the users 560.

FIG. 7 illustrates an exemplary computing system 700 that may be used to implement an embodiment of the present invention. System 700 of FIG. 7 may be implemented in the context of user devices 550, DNS server 510, Internet cloud 650 and the like. The computing system 700 of FIG. 7 includes one or more processors 710 and memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a graphics display 740, and other peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alphanumeric keypad, such as a keyboard, for inputting alphanumeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by a user device including but not limited to one or more of web sites, domains, web pages, web addresses, hyperlinks, URLs, any text, pictures, and/or media (such as video, audio, and any combination of audio and video) provided or displayed on a web page, and any combination thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for mediating an Internet service, the method comprising:
delivering the Internet service to a selected location, the location having an Internet connection operatively coupling at least one user device to the Internet service; and
executing instructions stored in a memory by a processor to prevent delivery of restricted Internet content via the Internet service to all users of a host network while a master mediation policy is enabled, the restricted Internet content comprising Internet content included in one or more categories of restricted Internet content of the master mediation policy.

2. The method according to claim 1, further comprising defining the Internet content included in the one or more categories of restricted Internet content by:
evaluating Internet content for subject matter; and
associating the Internet content with at least one of the one or more categories of restricted Internet content if the subject matter of the Internet content corresponds to at least one of the one or more categories of restricted Internet content.

3. The method according to claim 2, further comprising updating the one or more categories of restricted Internet content by:
identifying additional Internet content;
evaluating the subject matter of the additional Internet content; and
adding the additional Internet content to one or more of the restricted categories of the master mediation policy if the subject matter of the Internet content corresponds to at least one of the one or more categories of restricted Internet content.

4. The method according to claim 3, further comprising creating a master mediation policy by:
receiving input indicative of at least one selection corresponding to at least one of the one or more categories of restricted Internet content;
adding at least a portion of the Internet content of the selected categories of restricted Internet content to the master mediation policy; and
associating the master mediation policy with the Internet connection.

5. The method according to claim 3, wherein an end user may create an individualized mediation policy by specifying additional categories of restricted Internet content not included in the predefined categories to add to the master mediation policy, wherein the individualized mediation policy is applied to the Internet service when the end user is utilizing a user device operatively coupled to the Internet service.

6. The method according to claim 1, further comprising creating an additional category of restricted Internet content by:
receiving a request to create an additional category, wherein the request includes at least one of a category description and Internet content having evaluable subject matter; and
adding the additional category to the one or more categories of restricted Internet content.

7. The method according to claim 6, further comprising evaluating the request according to a predetermined category creation policy and adding the additional category to the one or more categories of restricted Internet content when the additional category complies with the predetermined category creation policy.

8. The method of claim 6, wherein the administrator adds specific Internet content not included within defined categories to the master mediation policy.

9. The method according to claim 6, wherein if the request includes Internet content having evaluable subject matter, evaluating includes:
evaluating the subject matter of the Internet content; and
creating a category corresponding to the subject matter of the Internet content if the category complies with the predetermined category creation policy.

10. The method according to claim 1, wherein an administrator provides input on the content of categories associated with the master mediation policy to a provider of the Internet service.

11. The method according to claim 1, wherein administrators of different networks share the contents of the master mediation policies.

12. The method according to claim 1, wherein any new devices added to the network are subject to the existing master mediation policy.

13. The method according to claim 1, wherein the administrator allows designated restricted Internet content to be delivered to specific end users although the master mediation policy is in effect.

14. The method according to claim 1, wherein selectively applying the master mediation policy to the Internet service includes:
receiving a request to access Internet content from a user device coupled to the Internet service;
comparing the requested Internet content to the master mediation policy; and
blocking a resolution performed by a DNS server if the requested Internet content is included in the master mediation policy.

15. The method according to claim 14, wherein blocking includes blocking a resolution performed by an Internet service provider if the requested Internet content is included in the master mediation policy.

16. The method according to claim 1, further comprising outputting a notification that access to the Internet content is prohibited by the master mediation policy.

17. The method according to claim 1, further comprising providing a notification to the administrator of attempted access to restricted Internet content included in the master mediation policy.

18. The method according to claim 1, wherein the Internet content includes any of a domain, a video, audio, and an application.

19. The method of claim 1, wherein at least one element of the master mediation policy is resident on the DNS server.

20. The method of claim 1, wherein at least one element of the master mediation policy is enforced by the DNS server.

21. The method of claim 1, wherein the administrator specifies different master mediation policies for different locations.

22. The method of claim 1, wherein at least a portion of the Internet service is resident on a user device.

23. A system for mediating an Internet service, the system comprising:
a memory for storing a mediation policy application; and
a processor to deliver the Internet service to a selected location, the location having an Internet connection operatively coupling at least one user device to the Internet service, the processor further executing the mediation policy application, the mediation policy application preventing delivery of restricted Internet content via the Internet service, the restricted Internet content comprising Internet content included in one or more categories of restricted Internet content of a master mediation policy adapted to be selectively applied to the Internet service.

24. The system according to claim 23, wherein the mediation policy application includes a category management module stored in memory and executable by the processor to define the Internet content included in the one or more categories of restricted Internet content by:
evaluating Internet content for subject matter; and
associating the Internet content with at least one of the one or more categories of restricted Internet content if the subject matter of the Internet content corresponds to at least one of the one or more categories of restricted Internet content.

25. The system according to claim 24 wherein the category management module creates an additional category of restricted Internet content by:
receiving a request to create an additional category, wherein the request includes at least one of a category description and Internet content having evaluable subject matter; and
adding the additional category to the one or more categories of restricted Internet content if the subject matter of the Internet content corresponds to at least one of the one or more categories of restricted Internet content.

26. The system according to claim 25, wherein the category management module is adapted to evaluate the request according to a predetermined category creation policy and add the additional category to the one or more categories of restricted Internet content when the additional category complies with the predetermined category creation policy.

27. The system according to claim 26, wherein if the request includes Internet content having evaluable subject matter, evaluate includes:
evaluate the subject matter of the Internet content; and
create a category corresponding to the subject matter of the Internet content if the category complies with the predetermined category creation policy.

28. The system according to claim 23, wherein the mediation policy application further includes a category updating module stored in memory and executable by the processor to update the one or more categories of restricted Internet content by:
locating additional Internet content;
evaluating the subject matter of the additional Internet content; and
adding the additional Internet content to one or more of the restricted categories corresponding to the subject matter of the additional Internet content.

29. The system according to claim 28, wherein the mediation policy application further includes a mediation policy management module stored in memory and executable by the processor to create a master mediation policy by:
receiving input indicative of at least one selection corresponding to at least one of the one or more categories of restricted Internet content;
adding at least a portion of the Internet content of the selected categories of restricted Internet content to the master mediation policy; and
associating the master mediation policy with the Internet connection.

30. The system according to claim 23, wherein an end user may create an individualized mediation policy by selecting one or more additional categories of restricted Internet content to add to the master mediation policy, wherein the individualized mediation policy is applied to the Internet connection when the end user is utilizing a user device operatively coupled to the Internet service.

31. The system according to claim 23, wherein selectively applying the master mediation policy to the Internet service includes:
receiving a request to access Internet content from a user device coupled to the Internet service;
comparing the requested Internet content to the master mediation policy; and
blocking a resolution performed by a DNS server if the requested Internet content is included in the master mediation policy.

32. The system according to claim 31, wherein blocking includes blocking a resolution performed by an Internet service provider if the requested Internet content is included in the master mediation policy.

33. The system according to claim 23, further comprising outputting a notification that access to the Internet content is prohibited by the master mediation policy.

34. The system according to claim 23, further comprising providing a notification to the administrator of attempted access to restricted Internet content included in the master mediation policy.

35. The system according to claim 23, wherein the Internet content includes any of a domain, a video, audio, and an application.

36. The system of claim 23, wherein at least one element of the master mediation policy is resident on the DNS server.

37. The system of claim 23, wherein at least one element of the master mediation policy is enforced by the DNS server.

38. The system of claim 23, wherein the administrator specifies different master mediation policies for different locations.

39. The system of claim 23, wherein at least a portion of the Internet service is resident on a user device.

40. A non-transitory computer readable storage medium having a program embodied thereon, the program executable by a processor in a computing system, the method comprising:
mediating an Internet service delivered to a selected location having an Internet connection operatively coupling at least one user device to the Internet service; and
preventing delivery of restricted Internet content via the Internet service, wherein restricted Internet content comprises Internet content included in one or more categories of restricted Internet content of a master mediation policy adapted to be selectively applied to the Internet service.

41. A method for mediating an Internet service, the method comprising:
delivering the Internet service to a selected location, the location having an Internet connection operatively coupling at least one user device to the Internet service via a DNS server; and
executing instructions stored in a memory by a processor to prevent delivery of restricted Internet content via the DNS server to all users of a host network while a master mediation policy is enabled, the restricted Internet content comprising Internet content included in one or more categories of restricted Internet content of the master mediation policy.

42. The method according to claim 41, further comprising defining in the DNS server one or more categories of restricted Internet content by:
evaluating Internet content for subject matter; and
associating the Internet content with at least one of the one or more categories of restricted Internet content if the subject matter of the Internet content corresponds to at least one of the one or more categories of restricted Internet content.

43. The method according to claim 42, further comprising updating the one or more categories of restricted Internet content in the DNS server by:
identifying additional Internet content;
evaluating the subject matter of the additional Internet content; and
adding the additional Internet content to one or more of the restricted categories of the master mediation policy if the subject matter of the Internet content corresponds to at least one of the one or more categories of restricted Internet content.

44. The method according to claim 43, further comprising creating a master mediation policy in the DNS server by:
receiving input indicative of at least one selection corresponding to at least one of the one or more categories of restricted Internet content;
adding at least a portion of the Internet content of the selected categories of restricted Internet content to the master mediation policy; and
associating the master mediation policy with the Internet connection.

45. The method according to claim 43, wherein an end user may create an individualized mediation policy by specifying additional categories of restricted Internet content not included in the predefined categories to add to the master mediation policy, wherein the individualized mediation policy is applied to the Internet service when the end user is utilizing a user device operatively coupled to the Internet service.

46. The method according to claim 41, further comprising creating an additional category of restricted Internet content in the DNS server by:
receiving a request to create an additional category, wherein the request includes at least one of a category description and Internet content having evaluable subject matter; and
adding the additional category to the one or more categories of restricted Internet content.

47. The method according to claim 46, further comprising evaluating the request according to a predetermined category creation policy and adding the additional category to the one or more categories of restricted Internet content when the additional category complies with the predetermined category creation policy.

48. The method of claim 44, wherein the administrator adds Internet content not included within defined categories to the master mediation policy in the DNS server.

49. The method according to claim 46, wherein if the request includes Internet content having evaluable subject matter, evaluating includes:
evaluating the subject matter of the Internet content; and
creating a category corresponding to the subject matter of the Internet content if the category complies with the predetermined category creation policy.

50. The method according to claim 41, wherein an administrator provides input on the content of categories associated with the master mediation policy to a provider of the Internet service.

51. The method according to claim 41, wherein administrators of different networks share the contents of the master mediation policies.

52. The method according to claim 41, wherein the administrator allows designated restricted Internet content to be delivered to specific end users although the master mediation policy is in effect.

53. The method according to claim 41, wherein selectively applying the master mediation policy to the Internet service includes:
receiving a request to access Internet content from a user device at the DNS server coupled to the Internet service;
comparing the requested Internet content to the master mediation policy; and
blocking a resolution performed by a DNS server if the requested Internet content is included in the master mediation policy.

54. The method according to claim 53, wherein blocking includes blocking a resolution performed by the DNS service provided by an Internet service provider if the requested Internet content is included in the master mediation policy.

55. The method according to claim 41, further comprising outputting a notification that access to the Internet content is prohibited by the master mediation policy.

56. The method according to claim 41, further comprising providing a notification to the administrator of attempted access to restricted Internet content included in the master mediation policy.

57. The method according to claim 41, wherein the Internet content includes any of a domain, a video, audio, and an application.

58. The method of claim 41, wherein the administrator specifies different mediation policies for different locations.

59. The method of claim 41, wherein at least a portion of the Internet service is resident on a user device.

60. A system for mediating an Internet service, the system comprising:
a memory for storing a mediation policy application; and
a processor to deliver the Internet service to a selected location, the location having an Internet connection operatively coupling at least one user device to the Internet service, the processor further executing the mediation policy application, the mediation policy application preventing delivery of restricted Internet content via the Internet service, the restricted Internet content comprising Internet content included in one or more categories of restricted Internet content of a master mediation policy adapted to be selectively applied to the Internet service.

61. The system according to claim 60, wherein the mediation policy application includes a category management module stored in memory and executable by the processor to define the Internet content included in the one or more categories of restricted Internet content by:
evaluating Internet content for subject matter; and
associating the Internet content with at least one of the one or more categories of restricted Internet content if the subject matter of the Internet content corresponds to at least one of the one or more categories of restricted Internet content.

62. The system according to claim 61 wherein the category management module creates an additional category of restricted Internet content by:
receiving a request to create an additional category, wherein the request includes at least one of a category description and Internet content having evaluable subject matter; and
adding the additional category to the one or more categories of restricted Internet content if the subject matter of the Internet content corresponds to at least one of the one or more categories of restricted Internet content.

63. The system according to claim 62, wherein the category management module is adapted to evaluate the request according to a predetermined category creation policy and add the additional category to the one or more categories of restricted Internet content when the additional category complies with the predetermined category creation policy.

64. The system according to claim 63, wherein if the request includes Internet content having evaluable subject matter, evaluate includes:
evaluate the subject matter of the Internet content; and
create a category corresponding to the subject matter of the Internet content if the category complies with the predetermined category creation policy.

65. The system according to claim 60, wherein the mediation policy application further includes a category updating module stored in memory and executable by the processor to update the one or more categories of restricted Internet content by:
locating additional Internet content;
evaluating the subject matter of the additional Internet content; and
adding the additional Internet content to one or more of the restricted categories corresponding to the subject matter of the additional Internet content.

66. The system according to claim 65, wherein the mediation policy application further includes a mediation policy management module stored in memory and executable by the processor to create a master mediation policy by:
receiving input indicative of at least one selection corresponding to at least one of the one or more categories of restricted Internet content;
adding at least a portion of the Internet content of the selected categories of restricted Internet content to the master mediation policy; and
associating the master mediation policy with the Internet connection.

67. The system according to claim 60, wherein an end user may create an individualized mediation policy by selecting one or more additional categories of restricted Internet content to add to the master mediation policy, wherein the individualized mediation policy is applied to the Internet connection when the end user is utilizing a user device operatively coupled to the Internet service.

68. The system according to claim 60, wherein selectively applying the master mediation policy to the Internet service includes:
receiving a request to access Internet content from a user device coupled to the Internet service;
comparing the requested Internet content to the master mediation policy; and
blocking a resolution performed by a DNS server if the requested Internet content is not included in the master mediation policy.

69. The system according to claim 68, wherein blocking includes blocking a resolution performed by an Internet service provider if the requested Internet content is included in the master mediation policy.

70. The system according to claim 60, further comprising outputting a notification that access to the Internet content is prohibited by the master mediation policy.

71. The system according to claim 61, further comprising providing a notification to an administrator of attempted access to restricted Internet content included in the master mediation policy.

72. The system according to claim 60, wherein the Internet content includes any of a domain, a video, audio, and an application.

73. The system according to claim 60, wherein an administrator specifies different mediation policies for different locations.

74. The system according to claim 60, wherein at least a portion of the Internet service is resident on a user device.
